(19) United States
(12) Patent Application Publication
(10) Pub. No.: US 2008/0005671 A1
(43) Pub. Date: Jan. 3, 2008

(54) Lossless Romanizing Schemes for Classic Sinhala and Tamil

(76) Inventor: Jayantha Chandrakumara Ahangama, Mansfield, TX (US)

Correspondence Address: J. C. Ahangama, 303 Londonderry Lane, Mansfield, TX, 76063, US

(21) Appl. No.: 11/428,383

(22) Filed: Jul. 1, 2006

(51) Int. Cl. G06F 17/00

(52) U.S. Cl. 715/535

(57) ABSTRACT

The two romanizing schemes for Sinhala and Tamil languages presented here are intuitive to learn. They are specially designed to make it easy to input to a computer using the regular QWERTY keyboard. This makes them comparable to the western European languages. Presently both these languages have Unicode based code blocks. That solution has introduced a permanent problem of isolating the indigenous speakers of these languages from benefiting from the advances in information technologies. Especially the Sinhalese being a small and poor group does not have the economies of scale to sustain a Sinhala-only computer user community. Romanizing releases these communities to the open world of Internet users expanding their horizons. Pali and Sanskrit are subsets of Sinhala and would benefit from it by becoming accessible to the wider world community.

### ROMANIZING

In this document, romanizing means that the underlying Unicode code points used for the language scripts would be within the Unicode Latin code charts. It does not advocate the abandonment of the traditional scripts. On the contrary, it provides a technologically superior way to conserve, manipulate and share texts of these languages, Pali, and Sanskrit that are subsets of Sinhala alphabet.

According to the Unicode Consortium, code points are only numbers that do not specify glyphs or shapes of alphabetic characters. These code points are designated names for what they are supposed to represent. For example, the LATIN CAPITAL LETTER A is the name of one of these. SINHALA LETTER A is another.

The latter is for the letter in the Sinhala alphabet that represents a similar sound that most languages use the former for. Though SINHALA LETTER A is specific for Sinhala, LATIN CAPITAL LETTER A is shared among many languages.

Perhaps the major reason for allocating different code pages for different languages is that it allows the same font to support two or more languages in the same font. For Example, a Unicode compliant font could have Latin characters in addition to Sinhala. The user would switch code pages by switching the keyboard layout.

However, a user to be able to use two languages sitting at different Unicode code blocks requires the computer to be reconfigured with special software. Besides, mostly people use one language to the exclusion of the other at a time. Since Latin has a greater variety of fonts, the user prefers to find the ideal one when using English, defeating the purpose of the font having more than one language.

It would be impossible for a computer configured for Unicode Sinhala or Tamil to communicate in that language with a computer that does not have such changes made to it. In effect, opting to use Unicode Sinhala/Tamil effectively isolates Sinhala/Tamil users to a special set of computers making others unable to communicate with them in those languages.

Our romanizing schemes give the same benefits that Latin alphabet users have to users of Sinhala and Tamil scripts. The advantage of using Latin code points is that those languages are able to exist virtually anywhere, as Latin character set is native to computers. A web page presumes ISO-8859-1 character set (Latin-1) if no other character set is specified. On the other hand, the special Unicode characters given to say, Sinhala cannot be expected to be supported on some arbitrary computer, at least not with the ease and comfort that Latin based alphabets enjoy. That also means that to be able to read web pages in Sinhala or Tamil the user's computer should already have those fonts and browser support.

### Romanizing Enhances Capabilities and Eliminates Problems

Both Tamil and Sinhala are ideal candidates for romanizing. Tamil has fewer characters than any Western European language. Sinhala has a number of characters comparable to a Western European language. Pali and Sanskrit are both subsets of the Classic Sinhala alphabet and would benefit from romanizing Sinhala. The Pali romanizing schemes are impossible to input from the keyboard. As such, they are input using special devices. This has made use of Pali in regular communication impossible. There is at least one Sanskrit transliteration scheme that is practical from the input angle. However, it is not at all intuitive to use and looks awkward to read.

Romanizing Tamil and Sinhala immediately allows messaging between any two computers without having to specially configure those computers. A person traveling would be able to retrieve and read messages at any Internet access service bureau. If a computer has a font that displays Latin code points in the native glyphs, then the text of that script would be able to be read and edited using that font.

A greater value of basing Sinhala and Tamil on Latin is the benefit it gives to store text mixed in the same document and yet to search using regular search devices without having to switch input methods. Whether a document is viewed or edited in native scripts or in Latin would be simply a user preference. A Plain Text document containing all three languages, English, Sinhala and Tamil would show readable text because it would have Romanized forms of Tamil and Sinhala. The same document could be prepared for presentation with different areas formatted using different fonts this time Sinhala and Tamil showing in their traditional scripts.

The input would be using the familiar QWERTY keyboard. When typing Tamil or Sinhala all but few keys would be used differently from English. The romanizing schemes given make that very intuitive as well. This provides considerable saving especially for Sri Lanka where the need for learning new input keyboard layouts becomes unnecessary.

### DESCRIPTION OF COLUMNS

The ‘Term’ columns of the following tables have the names of each character out of the the Tamil or Sinhala alphabet that is transliterated into a letter or digraph out of the Latin alphabet. The consonants also indicate that either Tamil ‘Pulli’ or Sinhala ‘Halkiriima’ mark is added to the base character. These marks are called Virama and Al-lakuna by Unicode. The names are same as those used in the Unicode code ranges, 0B80 to 0BFF and 0D80 to 0DFF—Tamil and Sinhala Unicode charts. The ‘Definition’ column contains the corresponding Latin characters or digraphs.

### Tamil Romanizing Scheme:

Definition List 1

| Term | Definition |
|---|---|
| TAMIL LETTER A | a |
| TAMIL LETTER AA | aa |
| TAMIL LETTER I | i |
| TAMIL LETTER II | ii |
| TAMIL LETTER U | u |
| TAMIL LETTER UU | uu |
| TAMIL LETTER E | e |
| TAMIL LETTER EE | ee |
| TAMIL LETTER AI | ai |
| TAMIL LETTER O | o |
| TAMIL LETTER OO | oo |
| TAMIL LETTER AU | au |

Definition List 2

| Term | Definition |
|---|---|
| TAMIL LETTER KA with PULLI | k |
| TAMIL LETTER NGA with PULLI | ñ |
| TAMIL LETTER CA with PULLI | c |
| TAMIL LETTER JA with PULLI | j |
| TAMIL LETTER NYA with PULLI | [symbol] |
| TAMIL LETTER TTA with PULLI | t |
| TAMIL LETTER NNA with PULLI | μ |

Definition List 3

| Term | Definition |
|---|---|
| TAMIL LETTER TA with PULLI | [symbol] |
| TAMIL LETTER NA with PULLI | n |
| TAMIL LETTER NNA with PULLI | N |
| TAMIL LETTER PA with PULLI | p |
| TAMIL LETTER MA with PULLI | m |

Definition List 4

| Term | Definition |
|---|---|
| TAMIL LETTER YA with PULLI | y |
| TAMIL LETTER RA with PULLI | r |
| TAMIL LETTER RRA with PULLI | R |
| TAMIL LETTER LLA with PULLI | I |
| TAMIL LETTER LLA with PULLI | ø |
| TAMIL LETTER LLLA with PULLI | L |
| TAMIL LETTER VA with PULLI | v |

Definition List 5

| Term | Definition |
|---|---|
| TAMIL LETTER SHA with PULLI | z |
| TAMIL LETTER SSA with PULLI | x |
| TAMIL LETTER SA with PULLI | s |
| TAMIL LETTER HA with PULLI | h |

### Sinhala Romanizing Scheme:

Definition List 6

| Term | Definition |
|---|---|
| Character | Romanized |
| SINHALA LETTER AYANNA | a |
| SINHALA LETTER AAYANNA | aa |
| SINHALA LETTER AEYANNA | æ |
| SINHALA LETTER AEEYANNA | ææ |
| SINHALA LETTER IYANNA | i |
| SINHALA LETTER IIYANNA | ii |
| SINHALA LETTER UYANNA | u |
| SINHALA LETTER UUYANNA | uu |

Definition List 7

| Term | Definition |
|---|---|
| SINHALA LETTER IRUYANNA | ü |
| SINHALA LETTER IRUUYANNA | üü |
| SINHALA LETTER ILUYANNA | ö |
| SINHALA LETTER ILUUYANNA | öö |

Definition List 8

| Term | Definition |
|---|---|
| SINHALA LETTER EYANNA | e |
| SINHALA LETTER EEYANNA | ee |
| SINHALA LETTER AIYANNA | ai |
| SINHALA LETTER OYANNA | o |
| SINHALA LETTER OOYANNA | oo |
| SINHALA LETTER AUYANNA | au |

Definition List 9

| Term | Definition |
|---|---|
| SINHALA LETTER AYANNA with ANUSVARAYA | á |
| SINHALA LETTER AAYANNA with ANUSVARAYA | aá |
| SINHALA LETTER IYANNA with ANUSVARAYA | í |
| SINHALA LETTER IIYANNA with ANUSVARAYA | ií |
| SINHALA LETTER UYANNA with ANUSVARAYA | u |
| SINHALA LETTER UUYANNA with ANUSVARAYA | uú |
| SINHALA LETTER EYANNA with ANUSVARAYA | é |
| SINHALA LETTER EEYANNA with ANUSVARAYA | eé |
| SINHALA LETTER OYANNA with ANUSVARAYA | ó |
| SINHALA LETTER OOYANNA with ANUSVARAYA | oó |

Definition List 10

| Term | Definition |
|---|---|
| SINHALA LETTER ALPAPRAANA KAYANNA | k |
| with HALKIRIIMA | |
| SINHALA LETTER MAHAAPRAANA KAYANNA | kh |
| with HALKIRIIMA | |
| SINHALA LETTER ALPAPRAANA GAYANNA | g |
| with HALKIRIIMA | |
| SINHALA LETTER MAHAAPRAANA GAYANNA | gh |
| with HALKIRIIMA | |
| SINHALA LETTER KANTAJA NAASIKYAYA | ñ |
| with HALKIRIIMA | |
| SINHALA LETTER SANYAKA GAYANNA | G |
| with HALKIRIIMA | |

Definition List 11

| Term | Definition |
|---|---|
| SINHALA LETTER ALPAPRAANA CAYANNA | c |
| with HALKIRIIMA | |
| SINHALA LETTER MAHAAPRAANA CAYANNA | ch |
| with HALKIRIIMA | |
| SINHALA LETTER ALPAPRAANA JAYANNA | j |
| with HALKIRIIMA | |
| SINHALA LETTER MAHAAPRAANA JAYANNA | jh |
| with HALKIRIIMA | |
| SINHALA LETTER TAALUJA NAASIKYAYA | ç |
| with HALKIRIIMA | |

Definition List 12

| Term | Definition |
|---|---|
| SINHALA LETTER ALPAPRAANA TTAYANNA | t |
| with HALKIRIIMA | |
| SINHALA LETTER MAHAAPRAANA TTAYANNA | th |
| with HALKIRIIMA | |
| SINHALA LETTER ALPAPRAANA DDAYANNA | d |
| with HALKIRIIMA | |
| SINHALA LETTER MAHAAPRAANA DDAYANNA | dh |
| with HALKIRIIMA | |
| SINHALA LETTER MUURDHAJA NAYANNA | μ |
| with HALKIRIIMA | |
| SINHALA LETTER SANYAKA DDAYANNA | D |
| with HALKIRIIMA | |

Definition List 13

| Term | Definition |
|---|---|
| SINHALA LETTER ALPAPRAANA TAYANNA | [symbol] |
| with HALKIRIIMA | |
| SINHALA LETTER MAHAAPRAANA TAYANNA | [symbol] h |
| with HALKIRIIMA | |
| SINHALA LETTER ALPAPRAANA DAYANNA | [symbol] |
| with HALKIRIIMA | |
| SINHALA LETTER MAHAAPRAANA DAYANNA | [symbol] h |
| with HALKIRIIMA | |
| SINHALA LETTER DANTAJA NAYANNA | n |
| with HALKIRIIMA | |
| SINHALA LETTER SANYAKA DAYANNA | [symbol] |
| with HALKIRIIMA | |

Definition List 14

| Term | Definition |
|---|---|
| SINHALA LETTER ALPAPRAANA PAYANNA | p |
| with HALKIRIIMA | |
| SINHALA LETTER MAHAAPRAANA PAYANNA | ph |
| with HALKIRIIMA | |
| SINHALA LETTER ALPAPRAANA BAYANNA | b |
| with HALKIRIIMA | |
| SINHALA LETTER MAHAAPRAANA BAYANNA | bh |
| with HALKIRIIMA | |
| SINHALA LETTER MAYANNA with HALKIRIIMA | m |
| SINHALA LETTER AMBA BAYANNA with HALKIRIIMA | B |

Definition List 15

| Term | Definition |
|---|---|
| SINHALA LETTER YAYANNA with HALKIRIIMA | y |
| SINHALA LETTER RAYANNA with HALKIRIIMA | r |
| SINHALA LETTER DANTAJA LAYANNA with | l |
| HALKIRIIMA | |
| SINHALA LETTER VAYANNA with HALKIRIIMA | v |

Definition List 16

| Term | Definition |
|---|---|
| SINHALA LETTER TAALUJA SAYANNA | z |
| with HALKIRIIMA | |
| SINHALA LETTER MUURDHAJA SAYANNA | x |
| with HALKIRIIMA | |
| SINHALA LETTER DANTAJA SAYANNA | s |
| with HALKIRIIMA | |
| SINHALA LETTER HAYANNA with HALKIRIIMA | h |
| SINHALA LETTER MUURDHAJA LAYANNA | ø |
| with HALKIRIIMA | |

Definition List 17

| Term | Definition |
|---|---|
| SINHALA LETTER AYANNA with VISARGAYA | ä |
| (JIHVAAMUULIYA) Not a Unicode character. Allophone of | q |
| Visargaya in Sanskrit | |
| SINHALA LETTER FAYANNA with HALKIRIIMA- | f |
| LAKUNA. Also, Upadhmaaniiya - Allophone of | |
| Visaraga in Sanskrit | |

What is claimed is:

1. The Sinhala transliteration scheme provides an alternative alphabet for the Sinhala language that is both practical to use and able to completely and comprehensively replace the traditional script of the language. It is a lossless mapping of all known base characters of the Sinhala alphabet, which includes Pali and Sanskrit. In the case of Sanskrit two rare allophones of one character is also given making it able to transliterate the oldest Sanskrit texts. The Latin characters used are drawn from the US-international keyboard used in Microsoft Windows® based computers and others that have compatible keyboard layouts. This makes it possible to use even Pali and Sanskrit in email messages without fear of degradation. Fonts could be designed for characters of traditional script mapping the Latin Unicode code points.

2. The Tamil transliteration provides an alternative to the Tamil Unicode code page based character set. It is useful on a computer that is not configured to use Tamil Unicode page based fonts. Fonts could be designed to incorporate Sanskrit characters to be used with Tamil using the transliteration mappings given in the tables herein.
